(19) United States
(12) Patent Application Publication
(10) Pub. No.: US 2025/0347986 A1
(43) Pub. Date: Nov. 13, 2025

(54) OPTICAL ALIGNMENT TECHNIQUES FOR LIGHT PROJECTION SYSTEM

(71) Applicant: TEXAS INSTRUMENTS INCORPORATED, Dallas, TX (US)

(72) Inventors: Taylor Byrum, Wylie, TX (US); Alexander Lyubarsky, Dallas, TX (US); Kristofer Oberascher, Van Alstyne, TX (US); Zachary Walker, McKinney, TX (US)

(21) Appl. No.: 19/201,070

(22) Filed: May 7, 2025

Related U.S. Application Data
(60) Provisional application No. 63/643,961, filed on May 8, 2024.

(51) Int. Cl. G03B 21/20; G02B 5/32

(52) U.S. Cl. CPC G03B 21/208; G02B 5/32; G03B 21/2013

(57) ABSTRACT

In one example, a system includes a phase light modulator and a non-transitory processor-readable storage device storing one or more computer generated holograms that describe optical wavefront correction and spatial alignment parameters for multiple light sources. The system may further include a processor coupled to the phase light modulator and to the storage device, the processor configurable to control the phase light modulator according to the one or more computer generated holograms to produce, responsive to light received from the multiple light sources, an illumination beam defined by the one or more computer generated holograms, the illumination beam comprising the light from the multiple light sources.

### CROSS-REFERENCE TO RELATED APPLICATION

This application claims priority to co-pending U.S. Provisional Application No. 63/643,961 filed on May 8, 2024 and titled “MULTI LIGHT SOURCE ALIGNMENT/WAVEFRONT MODIFICATION WITH PLM,” which is hereby incorporated herein by reference in its entirety.

### TECHNICAL FIELD

This description relates to light projectors, and more particularly, to light projection systems using multiple light sources to illuminate a spatial light modulator.

### BACKGROUND

Some optical projection systems use a spatial light modulator to project an image. When multiple light sources are used for illuminating the spatial light modulator (amplitude, phase, or both amplitude and phase), optical alignment among all the light sources, which may emit light of the same or different wavelengths/colors, can be difficult and may involve low tolerances and/or many degrees of freedom for the optical components in the system. For example, for optimal performance, two different light sources may need two different focusing lenses with different focal lengths to correctly focus the respective illumination beams onto the spatial light modulator. These issues can increase the number of optical components in the system, as well as the complexity and size of the overall optical system, thus driving high system costs.

### SUMMARY

In one example, a system comprises a phase light modulator, a non-transitory processor-readable storage device storing one or more computer generated holograms that describe optical wavefront correction and spatial alignment parameters for multiple light sources, and a processor coupled to the phase light modulator and to the storage device. The processor is configurable to control the phase light modulator according to the one or more computer generated holograms to produce, responsive to light received from the multiple light sources, an illumination beam defined by the one or more computer generated holograms, the illumination beam comprising the light from the multiple light sources.

In another example, a system comprises a plurality of light sources configured to emit a corresponding plurality of light beams, and a phase light modulator optically coupled to the plurality of light sources and configured to produce an illumination beam responsive to the plurality of light beams. The system further comprises a controller coupled to the phase light modulator and configurable to control the phase light modulator according to one or more computer generated holograms to spatially align the plurality of light beams in a far field of the phase light modulator to produce the illumination beam, and a spatial light modulator optically coupled to the phase light modulator and configured to project an image responsive to the illumination beam.

In another example, a method comprises modifying, according to a first computer generated hologram and with a first region of a phase light modulator, a first light beam incident on the first region of the phase light modulator from a first light source to apply optical wavefront correction to the first light beam to produce a first portion of an output beam from the phase light modulator, and modifying, according to a second computer generated hologram different from the first computer generated hologram and with a second region of the phase light modulator different from the first region, a second light beam incident on the second region of the phase light modulator from a second light source to apply optical wavefront correction to the second light beam to produce a second portion of the output beam that is spatially overlapped with the first portion of the output beam on an image plane in a far field of the phase light modulator.

### BRIEF DESCRIPTION OF THE DRAWINGS

FIG. 1A is a block diagram of a light projection system, according to an example.

FIG. 1B is a block diagram of a light projection system, according to another example.

FIG. 2A is a diagram showing multiple beam intensity profiles from multiple light sources, according to an example.

FIG. 2B is a diagram showing a point spread function, corresponding to a far-field beam profile, in which the beams of FIG. 2A are overlapped in the far field, according to an example.

FIG. 3A is a diagram conceptually illustrating a multi-function computer generated hologram, according to an example.

FIG. 3B is a diagram conceptually illustrating a set of computer generated holograms for multiple light sources, according to an example.

FIG. 4 is a block diagram of a portion of the light projection system of FIG. 1, according to an example.

FIG. 5A is a diagram illustrating application of multiple computer generated holograms for multiple light sources, according to an example.

FIG. 5B is a diagram illustrating application of an image-forming computer generated hologram, according to an example.

FIG. 6 is a diagram of a phase light modulator, according to an example.

FIG. 7 is a diagram of a portion of the light projection system of FIG. 1 including a feedback sensor, according to an example.

FIG. 8A is a flow diagram of a method of controlling a phase light modulator, according to an example.

FIG. 8B is a flow diagram of a method of modulating light beams according to one or more computer generated holograms using a phase light modulator, according to an example.

### DETAILED DESCRIPTION

Techniques are described for using a phase light modulator to modify light beams received from multiple different light sources so as to spatially align the light beams and/or to perform optical wavefront correction on the light beams. As described further below, by controlling the phase light modulator according to one or more computer generated holograms, the phase light modulator can be made to mimic one or more optical components, such as lenses or wedges, for example, to manipulate the light beams. In particular, using techniques described herein, the phase light modulator can be controlled to apply individual optical wavefront correction and/or alignment adjustments to different light beams from individual light sources. Thus, multiple degrees of freedom for configuring or optimizing system performance can be provided via the phase light modulator and controlled through software (e.g., executed by a controller coupled to the phase light modulator), which may reduce hardware costs and/or complexities associated with the system.

Accordingly, in one example, a system comprises a phase light modulator and a non-transitory processor-readable storage device storing one or more computer generated holograms that describe optical wavefront correction and spatial alignment parameters for multiple light sources. The system may further include a processor coupled to the phase light modulator and to the storage device. The processor may be configurable to control the phase light modulator according to the one or more computer generated holograms to produce, responsive to light received from the multiple light sources, an illumination beam defined by the one or more computer generated holograms, the illumination beam comprising the light from the multiple light sources.

### General Overview

In numerous systems and applications, multiple light sources are used to illuminate a spatial light modulator (SLM) (amplitude, phase, or both), which in turn projects an image responsive to illumination light and to image data received from a display controller. In such systems, achieving proper alignment of the light beams from multiple individual light sources at the spatial light modulator (or at a plane at which a surface of the spatial light modulator may be placed) can be challenging. Furthermore, the individual light sources may produce light beams with different optical characteristics, including different optical aberrations, for example. To spatially align the light beams, properly focus the individual light beams onto a desired plane, and correct for distortion or other optical aberrations using hardware components may involve large, complex, and potentially costly systems. For example, such systems may use opto-mechanical components, such as rotational and/or translational mounts for the light sources to allow for spatial positioning of the light beams, along with individual optical components, such as lenses, mirrors, prisms, etc., for each light source. In addition, to implement changes in such systems (e.g., to adapt to changing distortion characteristics or to alter the spatial alignment) may involve complex and/or costly hardware redesign.

To address these and other issues, examples described herein provide techniques by which to perform spatial alignment and optical wavefront correction for multiple light sources using a phase light modulator (PLM). As described further below, a controller for the phase light modulator (referred to herein as the PLM controller) can be programmed (e.g., in software and/or firmware) to control the phase light modulator to modulate light according to one or more computer generated holograms that describe optical wavefront correction and spatial alignment parameters for individual light sources. According to certain examples, if the incident light beams from different light sources are spatially separated on the phase light modulator, individual wavefront modifications can be applied for each light source. By altering one or more of the computer generated holograms, the wavefront modifications for any light source can be altered to respond to changing conditions and/or application parameters. Thus, the system may have degrees of freedom (e.g., the ability to modify several different properties or characteristics of multiple, individual light beams) that can be controlled through software/firmware, rather than hardware modifications, allowing for greater flexibility and responsiveness in the system.

Accordingly, in some examples, a system includes a plurality of light sources configured to emit a corresponding plurality of light beams, and a phase light modulator optically coupled to the plurality of light sources and configured to produce an illumination beam responsive to the plurality of light beams. The plurality of light sources may produce light beams of different wavelengths, or wavelength ranges (e.g., different colors), or may include multiple light sources for the same wavelength or wavelength range. The system may further include a controller coupled to the phase light modulator and configurable to control the phase light modulator according to one or more computer generated holograms to spatially align the plurality of light beams in a far field of the phase light modulator to produce the illumination beam. In some examples, the system further includes a spatial light modulator optically coupled to the phase light modulator and configured to project an image responsive to the illumination beam.

These and other aspects are described in more detail below.

### Example System Architecture

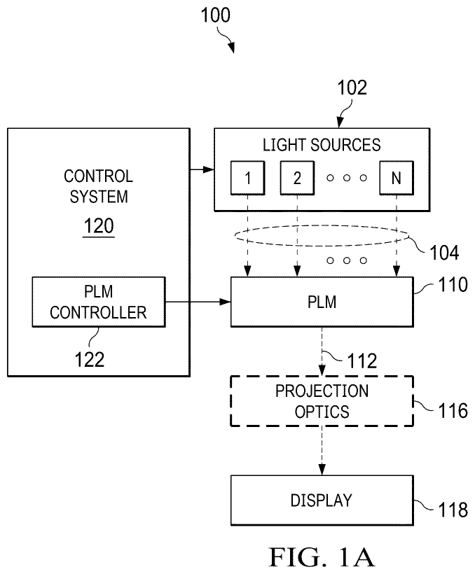

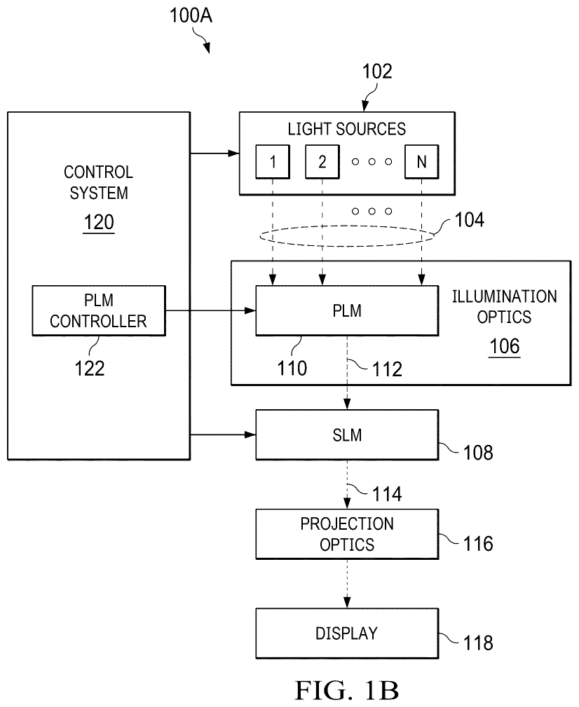

FIG. 1A is a block diagram of a light projection system 100, according to certain examples. In the illustrated example, the light projection system 100 includes a plurality of light sources 102 that produce respective light beams 104. The system 100 may include any integer number, N, of light sources 102 (and corresponding light beams 104). The light sources 102 may be laser diodes, light emitting diodes (LEDs) or other types of light sources. The system 100 further includes a phase light modulator (PLM) 110, a display surface 118, and a control system 120. The control system 120 can be configured to control operation of the plurality of light sources 102 and the phase light modulator 110. For example, as illustrated, the control system 120 includes a PLM controller 122 that controls operation of the phase light modulator 110, as described further below. In some examples, the control system 120 may include individual controllers (not shown) for the light sources 102 in addition to the PLM controller 122. In other examples, the control system 120 may include a single controller than controller the phase light modulator 110 and the light sources 102.

According to certain examples, the phase light modulator 110, under control of the PLM controller 122, modulates the incident light beams 104 to apply optical wavefront modifications to some or all of the light beams 104 to produce an output beam 112. As described further below, in applying the optical wavefront modifications, the phase light modulator 110 may mimic one or more optical elements (e.g., lenses, wedges, etc.) to control certain characteristics of the light beams 104 (such as focal point and spot size, for example). In some examples, the wavefront modifications applied by the phase light modulator 110 can spatially align (e.g., overlap or otherwise deliberately position) the plurality of light beams 104 to form the output beam 112. In some examples, the wavefront modifications applied by the phase light modulator 110 may correct for optical aberrations or distortion in some or all of the light beams 104. Examples of operation of the phase light modulator 110, and the PLM controller 122, are described further below.

In some examples, the phase light modulator 110 can be configured to produce the output beam 112 that projects an image in the far field of the phase light modulator. This image can be displayed on/by the display surface 118 positioned in the far field of the phase light modulator 110. In some examples, the display surface 118 may be a device or surface, such as a display screen, wall, roadway, glasses, or other surface or device on which an image may be displayed. In some examples, the phase light modulator 110 is optically coupled to the display surface 118 via projection optics 116. Accordingly, the projection optics 116, which may include one or more lenses, mirrors, and/or other optical elements, direct the output beam 112 from the phase light modulator 110 onto the display surface 118. In other examples, the projection optics 116 may be omitted. Although not shown in FIG. 1A, in some examples, illumination optics, including one or more lenses, mirrors, and/or other optical elements, may optically couple the phase light modulator 110 to one or more of the light sources 102.

FIG. 1B is a block diagram of another light projection system 100A, according to certain examples. In this example, the system 100A further includes a spatial light modulator (SLM) 108 that is optically coupled between the phase light modulator 110 and the display surface 118. In the example of FIG. 1B, illumination optics 106 direct the output beam 112 from the phase light modulator 110 to the spatial light modulator 108. In some examples, the illumination optics 106 consists of the phase light modulator 110. Although not shown in FIG. 1B, in other examples, the illumination optics 106 may include one or more optical elements (e.g., lenses, mirrors, etc.) that optically couple the phase light modulator 110 to one or more of the light sources 102, and/or one or more optical elements that optically couple the phase light modulator to the spatial light modulator 108. The spatial light modulator 108 modulates the output beam 112 to produce a projection beam 114. The spatial light modulator 108 may be optically coupled to the display surface 118 via the projection optics 116.

In the example of FIG. 1B, the control system 120 can be configured to control operation of the spatial light modulator 108 in addition to controlling the plurality of light sources 102 and the phase light modulator 110. In some examples, the control system may include an individual controller configured to control the spatial light modulator 108, in addition to the PLM controller 122 and optionally one or more controllers configured to control the light sources 102. In other examples, a common controller (e.g., including one or more processors and/or other circuitry) may control some or all aspects of operation of the light sources 102, the phase light modulator 110, and/or the spatial light modulator 108. Numerous variations and configurations may be apparent to those skilled in the art and are intended to be covered by this disclosure.

As described above, the plurality of light sources 102 may produce respective light beams 104. In some examples, the plurality of light sources 102 include one or more light sources for each of a plurality of different colors (e.g., red, green, and blue). In some examples, multiple light sources 102 are used for each color to achieve overall higher brightness in the output beam 112. Some or all of the light sources 102 may produce light beams 104 that have various optical aberrations resulting, for example, from manufacturing processes that produced the light sources 102. In some systems, such as those in which the illumination optics 106 are comprises of non-programmable optical elements, such as lenses and/or mirrors, for example, one may simply have to accept such aberrations (which may distort the image displayed on the display surface 118) or perform a potentially costly redesign of the system to correct for the aberrations. Similarly, in many instances, there may be misalignments among the plurality of light sources 102, resulting in a sub-optimal point spread function for the output beam 112 and/or blur in the output beam 112, either of which may degrade the resolution/quality of the projected image. In contrast, according to certain examples, because the phase light modulator 110 is a programmable optical element, it can be controlled (e.g., via the PLM controller 122) to manipulate the phase of the individual light beams 104 so as to correct for aberrations and/or misalignments without requiring hardware modifications to the illumination optics 106.

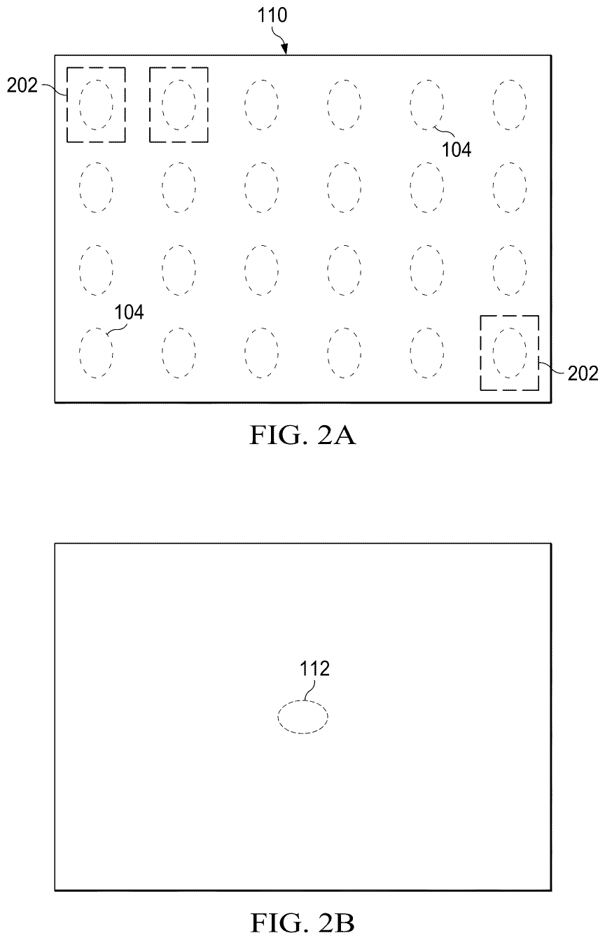

FIG. 2A illustrates an example in which a plurality of light beams 104 are incident on the phase light modulator 110. Each incident light beam 104 may be represented by a spatial distribution of intensity of the respective light beam 104 on a plane at which a surface of the phase light modulator 110 may be positioned. In this example, there are 24 individual light sources 102 arranged in a two-dimensional array (4×6) that produce, as illustrated, 24 corresponding light beams 104 that are incident on the phase light modulator 110. However, in other examples, there may be more than or fewer than 24 individual light sources 102, which may be arranged differently and thus produce light beams 104 that incident on the phase light modulator 110 in a pattern different than shown in FIG. 2A. Furthermore, although not specifically illustrated in FIG. 2A, individual light beams 104 can have different wavefront correction needs due to, for example, different characteristics of the individual light sources 102 and/or different positioning of the individual light sources 102 relative to the phase light modulator 110.

According to certain examples, the phase light modulator 110 can be controlled by the PLM controller 122 to spatially overlap the incident light beams 104 in the far field of the phase light modulator 110 so as to produce the output beam 112, illustrated in FIG. 2B, for example. To achieve this spatial overlap, and/or other wavefront modifications, the phase light modulator 110 can be controlled according to a plurality of computer generated holograms (CGHs) to appropriately manipulate the phase of the light beams 104. In examples in which the incident light beams 104 are spatially separated on the phase light modulator 110, as in the example of FIG. 2A, corresponding regions of the phase light modulator 110 can be individually controlled (e.g., by the PLM controller 122) according to individual, particular CGHs. Thus, as shown in FIG. 2A, individual CGH zones 202 can be applied to some or all of the incident light beams 104. These CGH zones 202 can be tailored such that the phase light modulator 110 modulates the phase of the individual light beams 104 so as to produce the output beam 112 having certain desired characteristics. For example, different CGH zones 202 can apply individual wavefront corrections to spatially overlap all the light beams 104 into a single far-field spot, as shown in FIG. 2B. The smaller the far-field spot size of the illumination beam, the better the image quality of the projected image from the spatial light modulator 108.

It will be appreciated that different wavefront modifications may be needed to reposition or redirect light beams 104 that are incident on different areas of the phase light modulator 110 such that the various light beams 104 overlap in the far field of the phase light modulator. Furthermore, different wavefront modifications to perform optical corrections (e.g., for focus and/or to correct optical aberrations) may be needed for different light beams 104. By tailoring the individual CGH zones 202 and controlling the corresponding specific regions of the phase light modulator 110, these different wavefront modifications can be applied without a need for multiple, individual external optical components (e.g., lenses, mirrors, etc.), thus offering a more compact, cost-effective solution. In addition, characteristics of the output beam 112 can be dynamically modified by modifying one or more of the CGH zones 202, thus offering significant flexibility and degrees of freedom that may be difficult to achieve with hardware-based configurations.

The phase light modulator 110 may be implemented in any of a variety of ways and may include devices such as a micro-mirror array, a phase-only liquid crystal on silicon (LCoS) device, or a deformable mirror device, for example. Micro-mirror based phase light modulators are microelectromechanical systems (MEMS) devices containing arrays of mirrors having heights adjustable with respect to the surface. In such devices, voltages applied to memory cells below individual mirrors adjust the heights of corresponding mirrors, which in turn imparts a phase variance to reflected light. In phase-only LCoS devices, light that is linearly polarized along the axis of the liquid crystal molecule may be used to illuminate the LCoS device. Voltages applied to the pixels of the device rotate the liquid crystal molecules to affect the phase of reflected light. Deformable mirrors are MEMS devices, including one or more mirrors, in which an applied voltage deforms a respective mirror by a variable amount and thereby affects the phase of reflected light. For any implementation of the phase light modulator 110, controlling the voltages (or currents) applied to the individual pixels of the device affects the phase of reflected light and may therefore be used to apply wavefront modifications, such as steering the reflected light in a particular direction (e.g., to achieve spatial overlap as described above with reference to FIG. 2B), or altering properties of the wavefront to correct aberrations or change focal distance, for example.

According to certain examples, a CGH may describe phase adjustments that the PLM controller 122 translates to voltages and/or currents to be applied to the pixels of any part of the array making up the phase light modulator 110. Accordingly, by controlling the phase light modulator 110, or individual regions thereof, according to one or more CGHs, the light beams 104 can be modified, steered, and/or encoded with image data to produce the output beam 112 having properties defined by the CGHs. For example, CGHs tailored for particular individual light sources 102 can cause the phase light modulator 110 to spatially overlap the respective light beams 104 to form the output beam 112 with a small far-field spot size, as described above. In some examples, a CGH zone 202 for any particular light source 102 (and corresponding incident light beam 104) may describe any one or more of several different functions, characteristics, or attributes to be applied as the phase light modulator 110 modulates the light beam 104 to produce the output beam 112. As described above, in some examples, an individual CGH zone 202 can describe phase adjustments to cause the phase light modulator 110 (or a particular region thereof) to mimic an optical element, such as a lens or wedge, for example, to focus and/or steer the light beam 104 in a particular manner. The CGH zone 202 may further describe phase adjustments to correct for optical aberrations and/or distortion. In addition, the CGH zone 202 may describe phase adjustments that correspond to attributes of an image to be encoded onto the output beam 112 such that, when the spatial light modulator 10 modulates the output beam 112 to produce the projection beam 114, the resulting image can be displayed on the display surface 118.

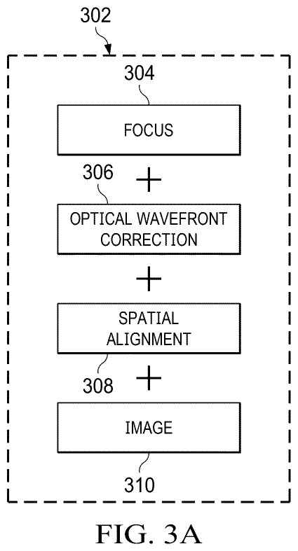

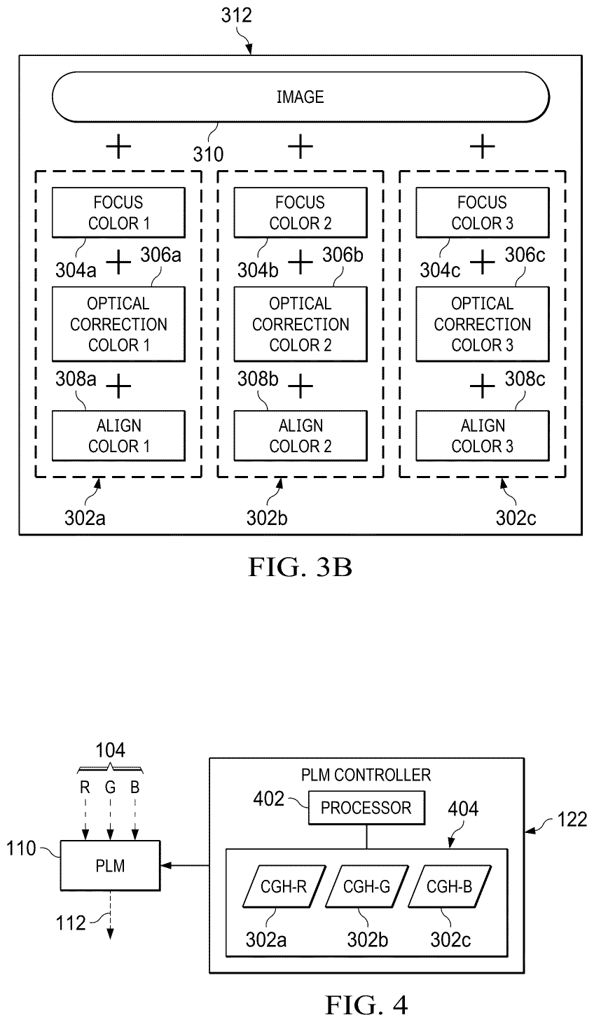

FIG. 3A is a block diagram conceptually illustrating an example of a CGH 302 that is configured to control the phase light modulator 110 to perform multiple functions to condition an incident light beam 104, and may therefore be termed a multi-function, or composite, CGH 302. The CGH 302 may represent, or may be applied by, any one or more of the CGH zones 202 illustrated in FIG. 2A, for example. In the example illustrated in FIG. 3A, the CGH 302 includes several individual CGHs that are configured to cause the phase light modulator 110 to implement particular functions, including focus (via a first CGH 304), optical wavefront correction (via a second CGH 306), spatial alignment (via a third CGH 308), and image formation (via a fourth CGH 310). Various examples of the CGH 302 may include any one or more of the individual CGHS 304, 306, 308, and/or 310 in any combination.

In some examples, the first CGH 304 may describe one or more optical elements, such as one or more lenses, for example, that focus the light beam 104 to a particular area in space. For example, the first CGH 304 can be configured to focus the light beam 104 onto an image plane in the far field of the phase light modulator 110 where the spatial light modulator 108 may be placed. To achieve the focusing function, the first CGH 304 can be configured to cause the region of the phase light modulator 110 to which it is applied to mimic a focusing lens, such as a parabolic lens, for example. In such examples, the first CGH 304 can be generated by determining the phase adjustments that correspond to a spatial profile and focal length of a lens that will focus the light beam 104 onto a plane in the far field of the phase light modulator 110. For example, a parabolic lens can be described by the following function:

$$Z = \frac{{x}^{2} + {y}^{2}}{4 f} \qquad ( F1 )$$

In function, F1, z describes the spatial profile (e.g., curvature) of the lens in terms of displacement (e.g., height) from an origin of the lens, f is the focal length of the lens and x and y represent spatial positions, relative to the origin, on the pixel array of the phase light modulator 110 according to:

$$x , y = m * p ( m = 0 , \pm 1 , \pm 2 , … )$$

wherein p is the pixel pitch of the array (e.g., 10.8 μm for some arrays). The focal length, f, can be determined empirically or by other methods, as described further below. Conversion of the displacement data, z, to phase (to produce the first CGH 304) is dependent on the wavelength (λ) of the light beam 104:

$$phase = - mod ( z , λ / 2 ) * 4 π / λ$$

Thus, given a known function/equation describing a focusing lens and a known wavelength of the light beam 104, the first CGH 304 can be generated to control the phase light modulator 110 (or a region thereof) to mimic that lens.

As described above, a CGH is a set of instructions to the phase light modulator 110 to create a certain spatially-dependent phase-delay. As also described above, a CGH can have multiple functions. Examples of such functions include optical functions, such as lensing, steering a beam, creating an image, or other types of wavefront corrective functions. In order to generate CGHs to perform these (or other) functions, the phase instructions are created. Depending on the function to be implemented via the CGH, the phase instructions may be created in any of various ways. In the case of a lens, for example, a conceptual height map may be created based on function F1. The height map is translated into phase space based on the wavelength of light, as described above. In the case of creating an image (e.g., to generate the fourth CGH 310), phase retrieval is often used and the Gerchberg-Saxton algorithm, discussed below, is one method that can be used to perform phase retrieval. Once the phase instructions are known, the individual effects of the various components of the CGH, 304, 306, 308 and 310 can be added together independently in phase space to create the desired effect of the outgoing beam in the far-field of the phase light modulator 110.

Thus, continuing with the example of FIG. 3A, the second CGH 306 for optical wavefront correction can be generated in a similar manner to the first CGH 304. For example, common optical aberrations, such as coma, astigmatism, etc., can be described by Zernike polynomials, from which spatial profiles of optical elements to correct for such aberrations can be derived. The spatial profile(s) can be described in terms of displacement data, z, as in the example function, F1, provided above. The displacement data can be converted to phase adjustments, as described above, to generate the second CGH 306.

In some examples, the third CGH 308 may describe the phase adjustments to spatially position the light beam at a particular location in the far field of the phase light modulator 110, for example, to spatially align the light beam 104 with one or more other light beams 104 from other light sources 102. In some examples, this spatial positioning, or beam steering, can be accomplished by controlling, according to the third CGH 308, the phase light modulator 110 (or a region thereof) to mimic an optical element (such as a wedge, for example) that acts as a tilted plane to impart a directional tilt (steer) to the light beam 104. For example, a tilted plane can be described in terms of displacement data, z, as in the above-discussed examples, that can be converted to phase adjustments to generate the third CGH 308. In some examples, the directional tilt can be applied to two dimensions to steer a light beam 104 incident on an upper/lower left/right area of the phase light modulator into a central area of the field of view, for example. Numerous variations will be apparent in light of this disclosure.

In some examples, the various CGHs (e.g., the first CGH 304, the second CGH 306, the third CGH 308, and the fourth CGH 310) can be stacked or combined in an additive manner. That is, each CGH 304, 306, 308, and/or 310 can be generated individually and the phase adjustments described for each pixel can be added together to generate the composite/multi-function CGH 302. Thus, modifications can be made individually to any of the first, second, third, and/or fourth CGHs 304, 306, 308, 310 without requiring any modification or re-generation of the other CGHs in the composite CGH 302. For example, for a given light source 102 (emitting a particular light beam 104), the first CGH 304 can be generated to focus the light beam 104 (e.g., with the smallest spot size practicable) onto a particular plane in the far field of the phase light modulator 110 (e.g., where the spatial light modulator 108 may be placed), the second CGH 306 can be generated to correct for any optical aberrations present in the light beam 104, and the third CGH 308 can be generated to precisely align or position the light beam 104 at a particular spatial location on the plane. A sum of the three CGHS 304, 306, 308 may thus produce a component of the output beam 112 (corresponding to the light beam 104) having good optical characteristics (e.g., minimal optical distortion and small focused spot size).

The fourth CGH 310 may be used to encode an image onto this component of the output beam 112. In some examples, the fourth CGH 310 can be generated from an algorithm, such as the Gerchberg-Saxton (GS) algorithm, where the wave propagation between the plane of the phase light modulator 110 and the image plane is mathematically approximated. The calculation is intended to identify the optimal phase hologram at the plane of the phase light modulator to generate the highest-quality image at the image plane. In this manner, the output beam 112 can be encoded with the fourth CGH 310 that creates an image at the image plane (e.g., at the display surface 118 or at the spatial light modulator 108).

Thus, for any light source 102 and corresponding light beam 104, an example of the CGH 302 can be generated. The PLM controller 122 may then control the phase light modulator 110 according to the CGH 302 to produce the output beam 112. As noted above, in the case of certain optical elements, such as a focusing lens for example, the phase adjustments to be effected by the phase light modulator 110 are dependent on the wavelength of the light beam 104. For example, the focal length of a lens to focus red light onto a given plane may be different from the focal length of a lens to focus green light or blue light onto the same plane. Accordingly, by applying individual CGH zones 202 for individual light sources 102, as described above, the phase adjustments described by a particular CGH zone 202 can be tailored for the precise wavelength of the light beam 104 emitted by a respective light source 102. This approach allows for each light beam 104 to be focused with a small spot size and minimal blur, which may improve the quality of the image displayed responsive to the output beam 112.

As described above, in some instances, multiple light sources 102 emitting light beams 104 of different colors, such as red, green, and blue, for example, can be used for the output beam 112. Accordingly, and at least in part to account for the differences in wavelength between the light of different colors, a CGH 302 can be generated for each color. FIG. 3B illustrates an example in which a control “program” 312 for the PLM controller 122 includes multiple CGHs configured for different light sources 102 emitting light beams 104 of different colors/wavelengths. In the illustrated example, there are three colors, with the program 312 including a first CGH 302a for the first color (color 1), a second CGH 302b for the second color (color 2), and a third CGH 302c for the third color (color 3). However, in other examples, the program 312 may include more than or fewer than three CGHs 302. As described above, any of the CGHs 302a-c may be configured for any one or more conditioning functions. In some examples, a type of CGH, such as the first CGH 302, for example, can be produced and then adjusted or scaled for individual colors to produce the respective CGHs 302a, 302b, 302c.

In the illustrated example, each of the CGHs 302a-c includes a respective first CGH 304a, 304b, 304c for focusing the respective colors, a respective second CGH 306a, 306b, 306c for performing optical corrections for the respective colors, and a respective third CGH 308a, 308b, 308c for spatially aligning the respective colors in the far field of the phase light modulator 110. However, in other examples, any one or more of the CGHs 302a-c may omit any one or more of the first CGHs 304a-c, the second CGHs 306a-c, and/or the third CGHs 308a-c. In some examples, the same image data may be applied for all three colors. Accordingly, in the example illustrated in FIG. 3B, the program 312 includes a single fourth CGH 310 for image formation that can be applied for all three colors. In other examples, however, different image data may be written for different colors. In such examples, the first, second, and/or third CGHs 302a-c may include individual fourth CGHs 310, as in the example of FIG. 3A.

Referring to FIG. 4, there is illustrated a block diagram of a portion of the light projection system of FIG. 1 showing the phase light modulator 110 and the PLM controller 122, according to an example. In this example, the light beams 104 incident on the phase light modulator 110 include red light (R), green light (G) and blue light (B). The PLM controller 122 includes at least one processor 402 and a non-transitory processor-readable storage device 404 coupled to the processor 402. The storage device 404 may include any one or more digital storage media that can be accessed by the processor 402, such as memory devices or other digital storage devices. For example, the storage device 404 may include one or more random-access memory (RAM) chips (which may include dynamic RAM and/or static RAM devices), one or more read-only memory (ROM) chips, one or more hard disk drives or other magnetic or optical storage media, one or more universal serial bus (USB) devices, one or more solid state drives (SSDs), such as a flash drive or other solid-state storage media, and/or one or more hybrid magnetic and SSD, flash memory, and/or RAM. The storage device 404 stores CGHs 302 that can be accessed by the processor 402 to generate control signals (e.g., voltages and/or currents) to drive the phase light modulator 110. These CGHs 302 may be multi-function CGHs as described above with reference to FIGS. 3A and 3B, for example. Thus, in the example illustrated in FIG. 4, the storage device 404 stores the first CGH 302a for the red light, the second CGH 302b for the green light, and the third CGH 302c for the blue light. The PLM controller 122 may control the phase light modulator 110 according to the stored CGHs 302a-c to modulate the light beams 104 to produce the output beam 112, as described above. In other examples, the processor 402 can be configured to generate and/or modify the CGHs 302 in real-time, rather than accessing pre-computed CGHs from the storage device 404. In some examples, one or more processors 402 that are part of the PLM controller 122 may control the phase light modulator 110 using the CGHs 302, as described above, and another controller (not shown in FIG. 4) that may or may not be part of the PLM controller 122 may produce the CGHs 302. Accordingly, in some examples, the CGHs 302 may be at least partly generated in advance, and in other examples, the CGHs 302 may be at least partially generated, or modified, in real time.

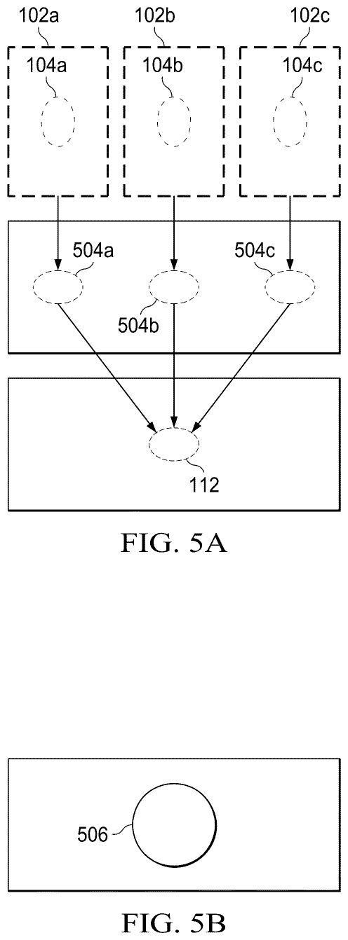

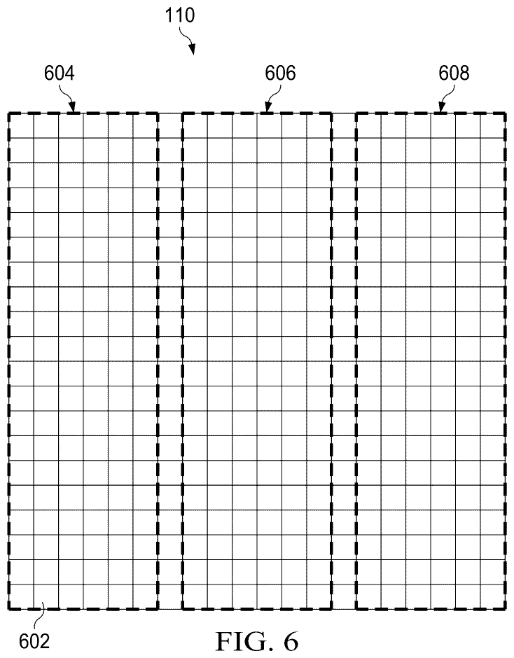

FIGS. 5A and 5B illustrate an example of controlling the phase light modulator 110 according to the CGHs 302a-c to modulate the light beams 104 of FIG. 4. Referring to FIG. 5A, in this example, three light sources 102a, 102b, 102c produce light beams 104a, 104b, 104c respectively. In some examples, the light beams 104a-c represent the red, green, and blue light, respectively, of FIG. 4. Prior to modulation by the phase light modulator 110, the light beams 104a-c may be unfocused and, in some instances, may include one or more types of optical aberration (e.g., coma, astigmatism, etc.). In some examples, by modulating the light beams 104a-c according to the respective CGHs 304a-c and 306ac-c, the phase light modulator 110 can produce corresponding conditioned light beams 504a-c, as shown in FIG. 5A. In some examples, the conditioned light beams 504a-c are corrected for tight focus onto a particular far-field plane (e.g., by applying the first CGHs 304a-c, respectively) and some or all optical aberrations (e.g., by applying the second CGHs 306a-c).

According to some examples, by applying the third CGHs 308a-c, the three conditioned light beams 504a-c can be spatially aligned in the far field of the phase light modulator 110, as described above. In the example illustrated in FIG. 5A, the three conditioned light beams are spatially overlapped to produce the output beam 112. However, in other examples, spatial alignment need not result in complete overlap of the conditioned light beams 504a-c. For example, the conditioned light beams 504a-c may be positioned adjacent one another (e.g., in a vertical, horizontal or diagonal line), partially overlapped, or otherwise deliberately arranged.

Referring to FIG. 5B, by applying the fourth CGHs 310a-c (or the common fourth CGH 310), an image 506 can be encoded onto the output beam 112. In the example shown in FIG. 5A, the image 506 is a circle. However, in other examples, the image 506 may include any symbol, character, picture, or other information. The clarity of the image 506 can be optimized through the conditioning (e.g., wavelength-dependent focus, correction for optical aberrations, and spatial alignment) applied to the light beams 104 via the first, second, and third CGHs 304a-c, 306a-c, and 308a-c.

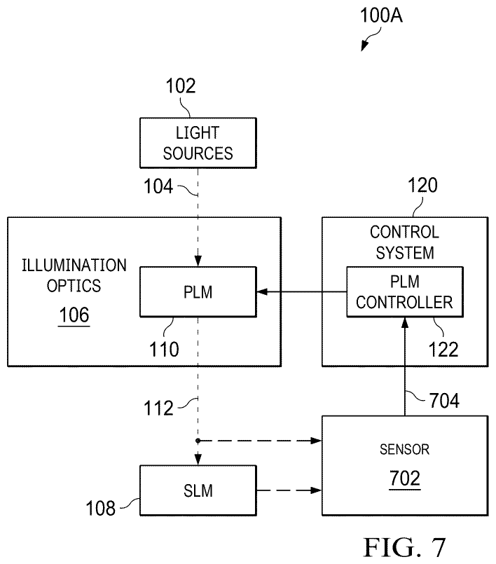

FIGS. 5A and 5B illustrate the wavefront modifications to the light beams 104a-c as a sequence of events for clarity of understanding how the light beams 104 are altered by controlling the phase light modulator 110 according to the various CGHs. However, it will be appreciated that in the systems 100, 100A, the CGHS 304, 306, 308, and 310 may not be applied as a sequence. Rather, as described above with reference to FIG. 3A, for any given light source 102 (and corresponding light beam 104) the individual CGHs 304, 306, 308, and 310 may be combined together to form a composite/multi-function CGH 302. The PLM controller 122 may control the phase light modulator 110 according to the CGH 302, such that all the functions (e.g., focus, optical wavefront correction, spatial alignment, and image formation) are performed simultaneously. In some examples, during a set-up or calibration procedure, the PLM controller 122 may control the phase light modulator 110 according to any one or more individual CGHs 304, 306, and/or 308 in order to fine tune the phase adjustments for any given function for any one or more individual light sources, as described further below with reference to FIG. 7.

As described above, in some instances, the systems 100, 100A may include more than one individual light source 102 for each color. Accordingly, in such examples, the program 312 may include single-function and/or multi-function CGHs 302 for some or all individual light sources 102 of one or more colors. In some examples, optical wavefront modifications can be performed for multiple light sources of the same color in the same manner as described above for multiple light sources of different colors.

As described above, in some instances, the multiple light beams 104 from respective individual light sources 102 are spatially separated on the phase light modulator 110, as illustrated in FIG. 2A, for example. In such examples, the different regions of the phase light modulator 110 can be controlled (via the PLM controller 122) according to different CGH zones 202, as described above. For example, FIG. 6 illustrates a representation of the phase light modulator 110 including a two-dimensional array of elements (e.g., pixels) 602. In some examples, the phase light modulator can be “divided” into multiple regions, such as the regions 604, 606, and 608 illustrated in FIG. 6. Each region 604, 606, 608 includes a plurality of pixels 602. In some examples, the regions 604, 606, 608 can be controlled by the PLM controller 122 according to different CGHs. For example, the region 604 may be controlled according to the first CGH 302a for red light, the region 606 may be controlled according to the second CGH 302b for green light, and the region 608 may be controlled according to the third CGH 302c for blue light. By individually controlling different regions of the phase light modulator 110, multiple CGHs can be applied simultaneously. Thus, for example, the phase light modulator 110 can be illuminated by red, green, and blue light simultaneously (provided that the individual colors incident on spatially distinct regions of the phase light modulator 110), and the corresponding individual regions 604, 606, 608 of the phase light modulator 110 can be controlled simultaneously according to the respective CGHs 302a-c.

In other examples, the respective CGHs for multiple colors (or multiple light sources of the same color) can be applied sequentially rather than simultaneously. For example, in some instances, the light beams 104 from various light sources 102 may not be fully spatially separated when incident on the phase light modulator 110. In such examples, the light sources 102 can be operated (e.g., by the control system 120) to emit the respective light beams 104 sequentially, and the phase light modulator 110 can be controlled according to a corresponding CGHs for each light source in the same sequence. In some examples, images are projected by the light projection system 100, 100A at a particular frame rate. In some such examples, during a frame period (e.g., the time for which a single frame of image data is displayed), multiple light sources 102 can be operated sequentially and the phase light modulator 110 can be similarly operated sequentially, at the same rate, to modulate each light beam 104 according to the appropriate CGH zone 202. For example, during a given frame period, a first light source 102 may emit the red light for a first time period, a second light source 102 may emit the green light for a second time period, and a third light source 102 may emit the blue light for a third time period. Accordingly, the phase light modulator 110 can be controlled to modulate the red light according to the first CGH 302a during the first time period, modulate the green light according to the second CGH 302b during the second time period, and modulate the blue light according to the third CGH 302c during the third time period.

Referring again to FIG. 6, in the illustrated example, the phase light modulator 110 is shown partitioned into three vertical regions 604, 606, 608. However, it will be appreciated that numerous other configurations of different regions of the phase light modulator 110 can be implemented. For example, the regions 604, 606, 608 may be horizontal “slices” of the phase light modulator array, rather than vertical slices as shown. In other examples, the regions 604, 606, 608 may be square or have another shape other than the rectangular shapes illustrated. In some examples, a combination of the regions 604, 606, 608 may cover all pixels 602 in the phase light modulator array, whereas in other examples, some pixels 602 may not be part of any region 604, 606, or 608. The regions 604, 606, 608 may be tailored depending on the area(s) in which the multiple light beams 104 are incident on the phase light modulator 110. Further, in various examples, the phase light modulator 110 can be partitioned into more than or fewer than the three regions 604, 606, 608 illustrated in FIG. 6.

As described above, in some instances, any one or more of the CGH zones 202 can be modified to fine tune the phase adjustments applied for a particular light source 102 to optimize imaging performance of the light projection systems 100, 100A. For example, the storage device 404 of the PLM controller 122 may store an initial first CGH 304a that describes a focusing lens for a particular light source 102, the focusing lens having an initial focal length. By observing the output beam 112 produced by the phase light modulator 110 in response to a light beam 104 from the light source 102 modulated according to the first CGH 304a, it may be determined that the focus of the light beam 104 is sub-optimal. Accordingly, the first CGH 304a can be updated to specify a different focal length, and the newly-produced output beam 112 may again be observed to determine whether the update to the first CGH 304a has improved the focus. This process can be iteratively repeated until a satisfactory result is achieved. The same process may be performed for other CGH zones 202 and other light sources 102. In some examples, adjustments to some or all CGH zones 202 stored by the storage device 404 can be performed as part of a calibration procedure for the light projection systems 100, 100A. As described above, in some examples, the phase light modulator 110 can be controlled (by the PLM controller 122) to modulate any particular light beam 104 according to one individual CGH zone 202 at a time, such that the effects of that individual CGH zone 202 can be observed, and adjustments to the CGH zone 202 made, without impact from any other CGHs that may ultimately be applied in combination with the particular CGH under test. For example, the phase light modulator 110 can be controlled to modulate the light beam 104a according to the first CGH 304a alone until an optimal configuration for the first CGH 304a is determined, and then modulate the light beam 104a according to the second CGH 306a alone until an optimal configuration for the second CGH 306a is determined. The same process may be applied for the third CGH 308a, and for the individual CGHs 304b-c, 306b-c and 308b-c using the respective light beams 104b and 104c, for example. Once satisfactory configurations for all CGHs 304a-c, 306a-c, 308a-c have been determined, these CGHs can be combined with the image formation CGH(s) 310(a-c) to form the composite CGHs 302a-c for the respective colors.

In some examples, tuning of the various CGH zones 202 can be performed manually, with a human operator observing the output beam 112 and making adjustments to the CGHs as necessary. However, in other examples, the light projection system 100 or 100A can be configured to perform a self-calibration process (or self-adjustment process) using sensor measurements (e.g., from a camera, photo-diode, or other sensor).

Turning to FIG. 7, illustrated is a block diagram of a portion of the light projection system 100A, according to an example. In this example, the system 100A includes a sensor 702 that is configured to acquire sensor measurements that can be used to modify any one or more CGHs stored in the storage device 404 of the PLM controller 122. The sensor 702 may include one or more cameras, photo-diodes, or other light-sensitive devices that can be used to observe characteristics of the output beam 112. It will be appreciated that the system 100 may similarly include the sensor 702 configured to observe characteristics of the output beam 112. In some examples, the sensor 702 is positioned to detect the output beam 112 directly. In other examples of the system 100A, the sensor 702 is positioned to detect light (e.g., the projection beam 114) projected by the spatial light modulator 108 in response to the output beam 112.

According to certain examples, the sensor 702 provides sensor data 704 to the PLM controller 122 (e.g., to the processor 402), the sensor data containing information that describes one or more properties or characteristics of the output beam 112. Responsive to the sensor data, the processor 402 may modify one or more of the stored CGHs to adjust the properties or characteristics of the output beam 112. For example, as described above, a stored CGH describing a lens with a particular focal length can be modified to change the focal length to improve focus of a particular light beam 104. Similarly, a stored CGH describing a tilt plane for a particular light source can be modified to adjust the tilt angle to better spatially align the respective light beam. Numerous variations may be apparent in light of this disclosure. In some examples, as described above, the CGHs 304, 306, 308 may describe respective optical elements in terms of parameterized functions. Accordingly, responsive to the sensor data 704, the processor 402 may iteratively adjust one or more parameters (e.g., focal length, f, in the function, F1) in a given function until a satisfactory solution is achieved (e.g., the corresponding characteristic of the light beam, such as focus, spatial position, etc.) is optimal, or as optimal as may be practicable in given application. In other examples, the sensor 702 may be a wavefront sensor that describes the corrections that may be needed to correct for particular optical aberrations. In such instances, tuning of the CGH(s) need not be iterative.

Thus, aspects and examples provide techniques by which a phase light modulator can be used in combination with one or more computer generated holograms to perform a variety of optical functions within a light projection system. For example, as described above, the phase light modulator, controlled according to the one or more CGHs, can mimic various optical elements to focus and/or spatially align light beams from multiple different light sources, and optionally to perform corrections for optical aberrations (such as coma, astigmatism, etc.) in any of the light beams. Accordingly, the phase light modulator can replace multiple optical elements (such as lenses, mirror, prisms, etc.) that may otherwise be needed in the illumination optics 106 of the light projection system 100, thus allowing for a smaller, more compact, more flexible, and less expensive overall system design.

### Example Methodology

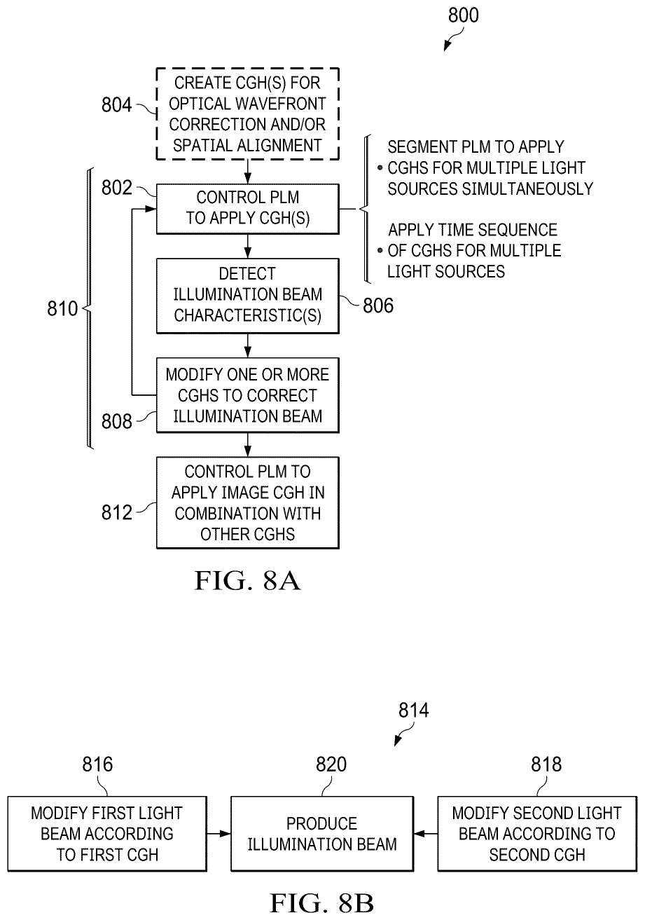

FIG. 8A is a flow diagram of a method 800 of operating the phase light modulator 110 according to certain examples.

At operation 802, the PLM controller 122 can be used to control the phase light modulator 110 to modulate one or more incident light beams 104 according to one or more CGHs, as described above. In some examples, operation 802 includes controlling the phase light modulator 110 according to multiple CGHs configured, respectively, for multiple individual light sources 102. Accordingly, in some examples, operation 802 includes segmenting the phase light modulator into multiple regions, as described above with reference to FIG. 6, for example, and controlling individual regions according to individual CGHs. In this manner, multiple light beams 104 from multiple light sources 102 can be modulated simultaneously according to respective CGHs, as described above. In other examples, multiple CGHs for multiple different light sources 102 can be applied individually in sequence over a time period, with the respective light sources operated to emit the respective light beams in a corresponding sequence over the same time period, as also described above.

According to certain examples, the CGH(s) applied at operation 802 may be configured to apply optical wavefront corrections to the light beams 104 from the light sources 102. For example, as described above, the CGHs can be configured to cause the phase light modulator 110 to perform functions such as beam steering (for spatial alignment) and/or beam focusing and/or correction for optical aberrations. Accordingly, in some examples, the method 800 optionally includes operation 804 of generating one or more CGHs for performing these wavefront correction and/or spatial alignment functions. In some examples, the CGHs generated at operation 804 may be stored by the PLM controller 122, for example, in the storage device 404.

As described above, in some examples, one or more of the CGHs used to control the phase light modulator 110 can be modified to tailor the CGH(s) to particular operating conditions of the light projection system 100. For example, the PLM controller 122 may be programmed with a set of initial (e.g., baseline) CGH(s) that generally describe one or more optical wavefront correction and/or spatial alignment parameters for multiple light sources. These initial CGHs can then be modified to optimize or otherwise tailor the light projection system 100 for particular light sources 102, a particular configuration of the system 100, or other operating and/or environmental conditions.

Accordingly, the method 800 may include an operation 806 of detecting one or characteristics of the output beam 112 produced by phase light modulator 110 responsive to modulating the light beams 104 according to the CGH(s) at operation 802. The characteristics of the output beam 112 that may be observed at operation 806 may include, for example, spot size, focus, spatial position, image blur, etc. As described above, in some examples, operation 806 may be performed by a human observer. In other examples, operation 806 may be performed using the sensor 702, as described above with reference to FIG. 7.

At operation 808, one or more of the CGH(s) can be updated responsive to the observations at operation 806. For example, a user may manually update one or more of the CGHs responsive to observing the output beam 112. In other examples, the PLM controller 122 (e.g., via the processor 402) can be configured to update one or more of the CGHs responsive to the sensor data 704 acquired from the sensor 702. For example, at operation 802 the phase light modulator 110 can be controlled to modulate a light beam 104 according to a CGH configured to focus that light beam onto a particular plane. If the sensor data 704 (acquired at operation 806) indicates that the focus is not within specified parameters (e.g., the spot size of the output beam 112 is larger than specified), the processor 402 may execute instructions to modify the CGH (e.g., to alter a focal length of a lens described by the CGH). In another example, at operation 802 the phase light modulator 110 can be controlled to modulate two or more lights beams 104 according to a respective CGHs configured to spatially overlap the light beams at a particular location. If the sensor data 704 (acquired at operation 806) indicates that there is misalignment among the light beams 104, the processor 402 may execute instructions to modify one or more of the CGHs (e.g., to alter a tilt angle described by the CGH) to reposition a corresponding one or more of the light beams 104 to improve the spatial overlap. Numerous other examples may be apparent in light of this disclosure.

In some examples, operations 802, 806, and 808 may be iteratively performed as part of a calibration procedure 810. As described above, in some examples, the calibration procedure 810 can be performed for one or more different colors individually or in combination and/or for one or more functions (e.g., spatial alignment, optical wavefront correction, etc.) individually or in combination.

At operation 812, with the output beam 112 produced from light from the multiple light sources having been calibrated/conditioned according to procedure 810, the phase light modulator 110 can be controlled according to an image-forming CGH (e.g., one or more image formation CGHs 310) in combination with one or more wavefront-modifying CGHs. For example, as described above, the phase light modulator 110 can be controlled according to a plurality of composite CGHs 302 (either simultaneously or in sequence), each CGH 302 describing wavefront correction parameters and image data parameters for a particular light source 102.

FIG. 8B illustrates a method 814 that can be performed by the phase light modulator 110 during operations 802 and/or 812, according to certain examples. FIG. 8B illustrates an example for two incident light beams; however, it will be appreciated that the method 814 may be extended for any number of incident light beams.

At operation 816, the phase light modulator 110 may modify, according to a first CGH, a first light beam (e.g., first light beam 104a of FIG. 5A) incident on the phase light modulator 110 from a first light source (e.g., first light source 102a of FIG. 5A) to apply optical wavefront correction to the first light beam. At operation 818, the phase light modulator 110 may modify, according to a second CGH, a second light beam (e.g., second light beam 104b of FIG. 5A) incident on the phase light modulator 110 from a second light source (e.g., second light source 102b of FIG. 5A) to apply optical wavefront correction to the second light beam. One or more similar operations may be performed for additional light beams from additional light sources, as described above.

In some examples, operation 816 can be performed using a first region of the phase light modulator 110, and operation 818 can be performed using a second region of the phase light modulator, as described above with reference to FIG. 6, for example. Accordingly, in some such examples, operations 816 and 818 may be performed simultaneously. In other examples, operations 816 and 818 may be performed in sequence.

At operation 820, as a result of the modifications performed at operations 816 and 818, the phase light modulator 110 produces an output beam, namely, the output beam 112. Accordingly, operation 816 may produce, responsive to the first light beam, a first portion of the output beam 112 output from the phase light modulator, and operation 818 may produce, responsive to the second light beam, a second portion of the output beam 112 output from the phase light modulator. As described above, in some examples, due to the phase adjustments applied according to the first and second CGHs at operations 816 and 818, respectively, the first and second portions of the output beam 112 are spatially overlapped with one another on an image plane in a far field of the phase light modulator 110.

### Conclusion

The above descriptions relating to light projection systems, imaging systems, and/or image display systems provide only some examples of environments or applications within which techniques and structures described herein may be implemented.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Elements that are “optically coupled” have an optical path between them. For example, element A and element B are optically coupled if light may travel from element A to element B and/or light may travel from element B to element A. Being optically coupled do not require light to be actively propagating between the elements. Optically coupled elements are in an arrangement where light, if present, is capable of propagating from element A to element B or from element B to element A. Additionally, elements that are optically coupled may have additional elements, for example lenses, mirrors, prisms, light tunnels, or other optical elements, in the light path between them.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

In this description, unless otherwise stated, “about,” “approximately” or “substantially” preceding a parameter means being within a range of that parameter, such as +/−10 percent of that parameter or +/−5 percent of that parameter.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain examples described herein can be practiced without certain, specific details. In other instances, well known methods, procedures, components, and circuitry have not been described in detail to avoid unnecessarily obscuring aspects of the examples. Accordingly, the scope of the present disclosure is defined by the appended claims rather than the foregoing description of examples.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### Further Examples

The following examples pertain to further arrangements and/or implementations, from which numerous permutations and configurations will be apparent.

Example 1 is a system comprising: a phase light modulator; a non-transitory processor-readable storage device storing one or more computer generated holograms that describe optical wavefront correction and spatial alignment parameters for multiple light sources; and a processor coupled to the phase light modulator and to the storage device, the processor configurable to control the phase light modulator according to the one or more computer generated holograms to produce, responsive to light received from the multiple light sources, an illumination beam defined by the one or more computer generated holograms, the illumination beam comprising light from the multiple light sources.

Example 2 includes the system of Example 1, wherein the one or more computer generated holograms include: a first computer generated hologram describing a first focusing lens for a first light source of the multiple light sources; and a second computer generated hologram describing a second focusing lens for a second light source of the multiple light sources.

Example 3 includes the system of Example 2, wherein the processor is configurable to control a first region of the phase light modulator according to the first computer generated hologram, and to control a second region of the phase light modulator according to the second computer generated hologram.

Example 4 includes the system of any one of Examples 1-3, further comprising a sensor coupled to the processor and configured to detect the illumination beam; wherein the processor is further configurable to modify at least one of the one or more computer generated holograms responsive to sensor data acquired from the sensor.

Example 5 includes the system of any one of Examples 1-4, wherein the optical wavefront correction and spatial alignment parameters include parameters that describe one or more of: focus for respective light from individual ones of the multiple light sources, optical aberration correction for the respective light from the individual ones of the multiple light sources, and spatial positioning of respective light from individual ones of the multiple light sources in a far field of the phase light modulator.

Example 6 includes the system of Example 5, wherein the spatial alignment parameters are configured to spatially overlap the respective light from the multiple light sources in the far field of the phase light modulator to produce the illumination beam.

Example 7 is a system comprising: a plurality of light sources configured to emit a corresponding plurality of light beams; a phase light modulator optically coupled to the plurality of light sources and configured to produce an illumination beam responsive to the plurality of light beams; a controller coupled to the phase light modulator and configurable to control the phase light modulator according to one or more computer generated holograms to spatially align the plurality of light beams in a far field of the phase light modulator to produce the illumination beam; and a spatial light modulator optically coupled to the phase light modulator and configured to project an image responsive to the illumination beam.

Example 8 includes the system of Example 7, further comprising a sensor optically coupled to the spatial light modulator and coupled to the controller; wherein the sensor is configured to produce sensor data responsive to one or more measurements of the image projected by the spatial light modulator; and wherein the controller is configurable to modify at least one of the one or more computer generated holograms responsive to the sensor data.

Example 9 includes the system of Example 8, wherein the sensor data indicates a misalignment of the plurality of light beams in the far field of the phase light modulator; and wherein the controller is configurable to modify the at least one of the one or more computer generated holograms based on the sensor data to spatially overlap the plurality of light beams in the far field of the phase light modulator to produce the illumination beam.

Example 10 includes the system of any one of Examples 7-9, wherein the one or more computer generated holograms include a computer generated hologram that describes the image to be projected by the spatial light modulator.

Example 11 includes the system of any one of Examples 7-10, wherein the controller is further configurable to control the phase light modulator according to the one or more computer generated holograms to perform optical wavefront correction on at least one of the plurality of light beams.

Example 12 includes the system of Example 11, wherein the optical wavefront correction comprises correction for coma and/or astigmatism in the at least one of the plurality of light beams.

Example 13 includes the system of any one of Examples 7-12, wherein the one or more computer generated holograms describe a respective focusing lens for each of the plurality of light beams to focus the illumination beam onto an image plane at the spatial light modulator.

Example 14 includes the system of any one of Examples 7-13, wherein the one or more computer generated holograms include a first computer generated hologram specifying first optical wavefront and spatial alignment parameters corresponding to a first light source of the plurality of light sources, and a second computer generated hologram specifying second optical wavefront and spatial alignment parameters corresponding to a second light source of the plurality of light sources; and wherein the controller is configurable to control a first region of the phase light modulator according to the first computer generated hologram, and to control a second region of the phase light modulator according to the second computer generated hologram.

Example 15 is a method comprising: modifying, according to a first computer generated hologram and with a first region of a phase light modulator, a first light beam incident on the first region of the phase light modulator from a first light source to apply optical wavefront correction to the first light beam to produce a first portion of an output beam from the phase light modulator; and modifying, according to a second computer generated hologram different from the first computer generated hologram and with a second region of the phase light modulator different from the first region, a second light beam incident on the second region of the phase light modulator from a second light source to apply optical wavefront correction to the second light beam to produce a second portion of the output beam that is spatially overlapped with the first portion of the output beam on an image plane in a far field of the phase light modulator.

Example 16 includes the method of Example 15, wherein modifying the first light beam with the first region of the phase light modulator is performed simultaneously with modifying the second light beam with the second region of the phase light modulator.

Example 17 includes the method of one of Examples 15 or 16, further comprising modulating, with the first and second regions of the phase light modulator, respectively, the first and second light beams according to a third computer generated hologram to encode an image into the output beam.

Example 18 includes the method of any one of Examples 15-17, further comprising: detecting at least one characteristic of the output beam using an optical sensor; and modifying at least one of the first computer generator hologram or the second computer generated hologram based on sensor data from the optical sensor.

Example 19 includes the method of any one of Examples 15-18, wherein the first computer generated hologram describes a first focusing lens; wherein modifying the first light beam with the first region of the phase light modulator includes focusing the first portion of the output beam onto the image plane; wherein the second computer generated hologram describes a second focusing lens different from the first focusing lens; wherein modifying the second light beam with the second region of the phase light modulator includes focusing the second portion of the output beam onto the image plane; and wherein the first light beam is of a different color than the second light beam.

Example 20 includes the method of any one of Examples 15-19, further comprising controlling a spatial light modulator positioned at the image plane to project an image responsive to the output beam.

Example 21 is a system including the phase light modulator and configurable to implement the method of any one of Examples 15-20.

Example 22 is a method of spatially aligning illumination beams from multiple light sources using a phase light modulator that is controlled according to multiple computer generated holograms, individual ones of the multiple computer generated holograms being configured to adjust properties/characteristics of respective illumination beams from respective individual ones of the multiple light sources.

Example 23 is a system comprising the phase light modulator and a phase light modulator controller, the system configured to perform the method of Example 22.

1. A system comprising:
a phase light modulator;
a non-transitory processor-readable storage device storing one or more computer generated holograms that describe optical wavefront correction and spatial alignment parameters for multiple light sources; and
a processor coupled to the phase light modulator and to the storage device, the processor configurable to control the phase light modulator according to the one or more computer generated holograms to produce, responsive to light received from the multiple light sources, an illumination beam defined by the one or more computer generated holograms, the illumination beam comprising light from the multiple light sources.

2. The system of claim 1, wherein the one or more computer generated holograms include:
a first computer generated hologram describing a first focusing lens for a first light source of the multiple light sources; and
a second computer generated hologram describing a second focusing lens for a second light source of the multiple light sources.

3. The system of claim 2, wherein the processor is configurable to control a first region of the phase light modulator according to the first computer generated hologram, and to control a second region of the phase light modulator according to the second computer generated hologram.

4. The system of claim 1, further comprising:
a sensor coupled to the processor and configured to detect the illumination beam;
wherein the processor is further configurable to modify at least one of the one or more computer generated holograms responsive to sensor data acquired from the sensor.

5. The system of claim 1, wherein the optical wavefront correction and spatial alignment parameters include parameters that describe one or more of: focus for respective light from individual ones of the multiple light sources, optical aberration correction for the respective light from the individual ones of the multiple light sources, and spatial positioning of respective light from individual ones of the multiple light sources in a far field of the phase light modulator.

6. The system of claim 5, wherein the spatial alignment parameters are configured to spatially overlap the respective light from the multiple light sources in the far field of the phase light modulator to produce the illumination beam.

7. A system comprising:
a plurality of light sources configured to emit a corresponding plurality of light beams;
a phase light modulator optically coupled to the plurality of light sources and configured to produce an illumination beam responsive to the plurality of light beams;
a controller coupled to the phase light modulator and configurable to control the phase light modulator according to one or more computer generated holograms to spatially align the plurality of light beams in a far field of the phase light modulator to produce the illumination beam; and
a spatial light modulator optically coupled to the phase light modulator and configured to project an image responsive to the illumination beam.

8. The system of claim 7, further comprising:
a sensor optically coupled to the spatial light modulator and coupled to the controller;
wherein the sensor is configured to produce sensor data responsive to one or more measurements of the image projected by the spatial light modulator; and
wherein the controller is configurable to modify at least one of the one or more computer generated holograms responsive to the sensor data.

9. The system of claim 8, wherein the sensor data indicates a misalignment of the plurality of light beams in the far field of the phase light modulator; and
wherein the controller is configurable to modify the at least one of the one or more computer generated holograms based on the sensor data to spatially overlap the plurality of light beams in the far field of the phase light modulator to produce the illumination beam.

10. The system of claim 7, wherein the one or more computer generated holograms include a computer generated hologram that describes the image to be projected by the spatial light modulator.

11. The system of claim 7, wherein the controller is further configurable to control the phase light modulator according to the one or more computer generated holograms to perform optical wavefront correction on at least one of the plurality of light beams.

12. The system of claim 11, wherein the optical wavefront correction comprises correction for coma and/or astigmatism in the at least one of the plurality of light beams.

13. The system of claim 7, wherein the one or more computer generated holograms describe a respective focusing lens for each of the plurality of light beams to focus the illumination beam onto an image plane at the spatial light modulator.

14. The system of claim 7, wherein:
the one or more computer generated holograms include
a first computer generated hologram specifying first optical wavefront and spatial alignment parameters corresponding to a first light source of the plurality of light sources, and
a second computer generated hologram specifying second optical wavefront and spatial alignment parameters corresponding to a second light source of the plurality of light sources; and
the controller is configurable to control a first region of the phase light modulator according to the first computer generated hologram, and to control a second region of the phase light modulator according to the second computer generated hologram.

15. A method comprising:
modifying, according to a first computer generated hologram and with a first region of a phase light modulator, a first light beam incident on the first region of the phase light modulator from a first light source to apply optical wavefront correction to the first light beam to produce a first portion of an output beam from the phase light modulator; and
modifying, according to a second computer generated hologram different from the first computer generated hologram and with a second region of the phase light modulator different from the first region, a second light beam incident on the second region of the phase light modulator from a second light source to apply optical wavefront correction to the second light beam to produce a second portion of the output beam that is spatially overlapped with the first portion of the output beam on an image plane in a far field of the phase light modulator.

16. The method of claim 15, wherein modifying the first light beam with the first region of the phase light modulator is performed simultaneously with modifying the second light beam with the second region of the phase light modulator.

17. The method of claim 15, further comprising:
modulating, with the first and second regions of the phase light modulator, respectively, the first and second light beams according to a third computer generated hologram to encode an image into the output beam.

18. The method of claim 15, further comprising:
detecting at least one characteristic of the output beam using an optical sensor; and
modifying at least one of the first computer generator hologram or the second computer generated hologram based on sensor data from the optical sensor.

19. The method of claim 15, wherein:
the first computer generated hologram describes a first focusing lens;
modifying the first light beam with the first region of the phase light modulator includes focusing the first portion of the output beam onto the image plane;
the second computer generated hologram describes a second focusing lens different from the first focusing lens;
modifying the second light beam with the second region of the phase light modulator includes focusing the second portion of the output beam onto the image plane; and
the first light beam is of a different color than the second light beam.

20. The method of claim 15, further comprising:
controlling a spatial light modulator positioned at the image plane to project an image responsive to the output beam.
